(19) United States
(12) Patent Application Publication
(10) Pub. No.: US 2013/0125754 A1
(43) Pub. Date: May 23, 2013

(54) SYSTEMS AND METHODS FOR IMPROVED BAGHOUSE FILTERS

(71) Applicants: Dennis W. Johnson, Simpsonville, SC (US); James H. Brown, Simpsonville, SC (US); Michael J. Martin, Greer, SC (US)

(72) Inventors: Dennis W. Johnson, Simpsonville, SC (US); James H. Brown, Simpsonville, SC (US); Michael J. Martin, Greer, SC (US)

(73) Assignee: FLUOR TECHNOLOGIES CORPORATION, Aliso Viejo, CA (US)

(21) Appl. No.: 13/302,149

(22) Filed: Nov. 22, 2011

(51) Int. Cl. B01D 46/04; B23P 17/04

(52) U.S. Cl. 95/280; 55/282; 55/302; 55/301; 95/278; 95/279; 29/401.1

(57) ABSTRACT

A headgear assembly for a baghouse filter can include a headgear configured to allow for concentric arrangement of first and second filters coupled thereto, where at least one of the first filter, second filter, and headgear can include an opening through which accumulated particulate from the second filter can pass. The headgear assembly can also include a cleaning assembly configured to facilitate cleaning of at least one of the first and second filters. Methods of facilitating on-line cleaning of a baghouse filter are also described wherein an exhaust stream is passed through concentrically arranged first and second filters to produce a filtered stream. At least one of the first and second filters can be cleaned using a cleaning assembly to remove accumulated particulate, which can pass through an opening in at least one of the first filter, the second filter, and the headgear.

### FIELD OF THE INVENTION

The field of the invention is filtration systems, and specifically, baghouse filters.

### BACKGROUND

Existing fabric filters are generally capable of removing up to 99% of particulate from a particulate-laden stream. However, recent revisions to the Clean Air Act and other laws that deal with particulates, fine particulate, and metal hazardous air pollutants (HAPS) will likely require an even greater amount of particulate removal. For example, the March 2011 proposed EPA Utility Boiler MACT (40 CFR Parts 60 and 63—National Emission Standards for Hazardous Air Pollutants from Coal- and Oil-fired Electric Utility Steam Generating Units and Standards of Performance for Fossil-Fuel-Fired Electric Utility, Industrial-Commercial-Institutional, and Small Industrial-Commercial-Institutional Steam Generating Units) requires that new units have total particulate (filterable plus condensable) emissions less than 0.050 lb per MWh. For new units to comply, particulate emissions will need to be reduced by more than 50% using the current best performance fabric filter, and in some cases, as much as 90% or more of the remaining particulate must be removed.

FIG. 1 illustrates a prior art bag filter, which include filter bags placed in hollow cages. The outside of the filter bags filter flyash and other particulate as the stream passes through the bags. The filtered gas can then flow through the cages to the exit plenum. Unfortunately, these prior art configurations are typically not sufficient to remove the amount of particulate required under the new standards.

Fabric filters have seen various improvements including, for example, new bag materials and coatings, the use of pleated or fluted bags (e.g., WIPO publ. no. 2009/062017 to Kohli, et al. (publ. May 2009)), the use of oval bags and cages, the increase of bag collection surface, the reduction of the velocity in the bag house, the use of bag leak detection, and the use of longer bags and cages. However, even with these advancements, a significant amount of residual ash remains.

Various other configurations of fabric filters known in the art are described in U.S. Pat. No. 4,259,095 to Johnson, Jr.; U.S. Pat. No. 7,250,387 to Durante, et al.; U.S. Pat. No. 7,947,110 to Taylor; U.S. patent publ. no. 2008/0105121 to Chang (publ. May 2008); U.S. patent publ. no. 2009/0320678 to Chang, et al. (publ. December 2009); UK patent appl. no. 2462516 to Taylor; and UK patent appl. no. 2454561 to Hanson, et al.

These and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

Thus, there is still a need for filtration devices that increase the amount of particulate captured in an exhaust stream.

### SUMMARY OF THE INVENTION

The inventive subject matter provides apparatus, systems and methods in which one can utilize a headgear assembly for a baghouse filter to improve the collection efficiency of the baghouse or other fabric filters and an associated baghouse. Because the majority of flyash and other particulate is removed by the baghouse filter in a baghouse, the collection efficiency of the baghouse filter can be improved by utilizing a secondary filter downstream of a primary filter.

In some contemplated embodiments, the headgear assembly can include a headgear configured to allow for concentric arrangement of first and second filters, which are each coupled to the headgear. A cleaning assembly can be configured to facilitate cleaning of at least one of the first and second filters. In preferred embodiments, the cleaning assembly comprises a pulse or reverse air supply configured to provide pulsed or reverse air, respectively, to at least one of the first and second filters via a conduit. However, in alternative embodiments, the cleaning assembly can include shakers, rappers, or other commercially-suitable mechanical devices.

In preferred embodiments, at least one of the first filter, the second filter, and the headgear includes a resealable opening through which accumulated particulate from the second filter can pass to thereby allow for on-line cleaning of the second filter by removing at least some of the particulate from the second filter without necessitating removal of the second filter.

In one aspect, a method for facilitating on-line cleaning of a baghouse filter includes passing an exhaust stream through concentrically arranged first and second filters to produce a filtered stream. A cleaning assembly can be used to clean at least one of the first and second filters. In some contemplated embodiments, air can be pulsed to at least one of the first and second filters from a pulsed air supply to remove accumulated particulate from at least one of the first and second filters. At least a portion of the accumulated particulate can pass through an opening in at least one of the first filter, the second filter, and the headgear to thereby allow for removal of the accumulated particulate.

Unless the context dictates the contrary, all ranges set forth herein should be interpreted as being inclusive of their endpoints, and open-ended ranges should be interpreted to include commercially practical values. Similarly, all lists of values should be considered as inclusive of intermediate values unless the context indicates the contrary.

Methods for retrofitting a baghouse having a plurality of primary filters are also contemplated. A headgear configured to allow concentric arrangement a second filter with respect to the primary filter can be installed to at least one of the primary filters. At least one of the primary filter, the second filter, and the headgear can include a resealable opening through which at least a portion of the accumulated particulate from the second filter can pass. In this manner, particulate that accumulates on the second filter can be dislodged and pass through the resealable opening to be removed by a suction tube or other means. It is contemplated that the headgear can be coupled to a cleaning assembly to allow for on-line cleaning of at least one of the primary and second filters.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is a schematic of prior art baghouse.

FIGS. 2A and 2B are side and top views, respectively, of a schematic of one embodiment of a baghouse filter.

FIG. 3 is a side view of a schematic of another embodiment of a baghouse filter.

FIGS. 4A and 4B are side and top views, respectively, of yet another schematic of one embodiment of a baghouse filter.

FIG. 5 is a flowchart of a method of facilitating on-line cleaning of a baghouse filter.

FIG. 6 is a flowchart of a method of retrofitting a baghouse having a plurality of primary filters.

### DETAILED DESCRIPTION

One should appreciate that the disclosed techniques provide many advantageous technical effects including the improvement of the collection efficiency of a baghouse. It is contemplated that the systems, methods, and apparatus discussed herein could be used in virtually all applications of baghouses, and would be applicable to coal-fired power or steam power plants as well as other processes that have a particulate removal device including, for example, electrical power production, mining, pulp and paper, refining, and steel processing. The inventive subject matter could also apply to vents that utilize baghouses including, for example, silo vents.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

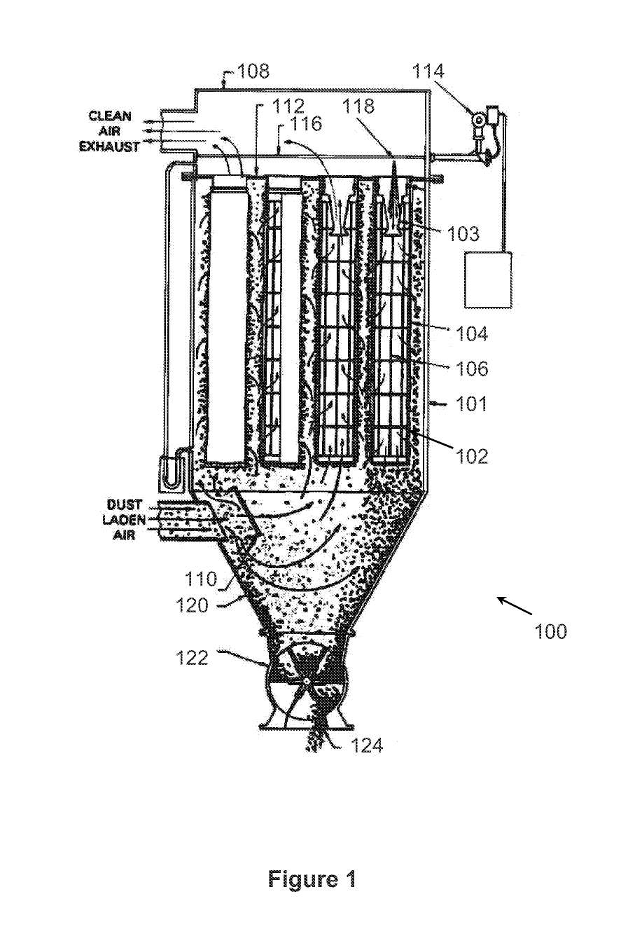

In FIG. 1, a prior art baghouse 100 is shown having a housing 101 that encompasses a plurality of baghouse filters 102, each of which includes a venturi 103 and a filter bag 104 disposed within a retainer or cage 106. Each of the baghouse filters 102 can be coupled to a tube sheet 112, from which the baghouse filters 102 can hang. Dust laden air or gas can enter into the housing 101 and pass by a diffuser 110. The dust laden air or gas can be filtered as it passes through the filter bags 104. The filtered air can then pass through exit plenum 108 and exit as clean air or gas exhaust.

The baghouse 100 can be fluidly coupled to a compressed air supply 114 from which pulsed air can flow through a blow pipe 116 and exit one or more nozzles 118 to thereby provide pulsed air to the baghouse filters 102. The pulsed air can be used to clean the filter bags 104 by removing at least some of the particulate on an outside of the filter bags 104. The removed particulate 124 can then be collected in hopper 120 where it can be removed through a rotary airlock 122.

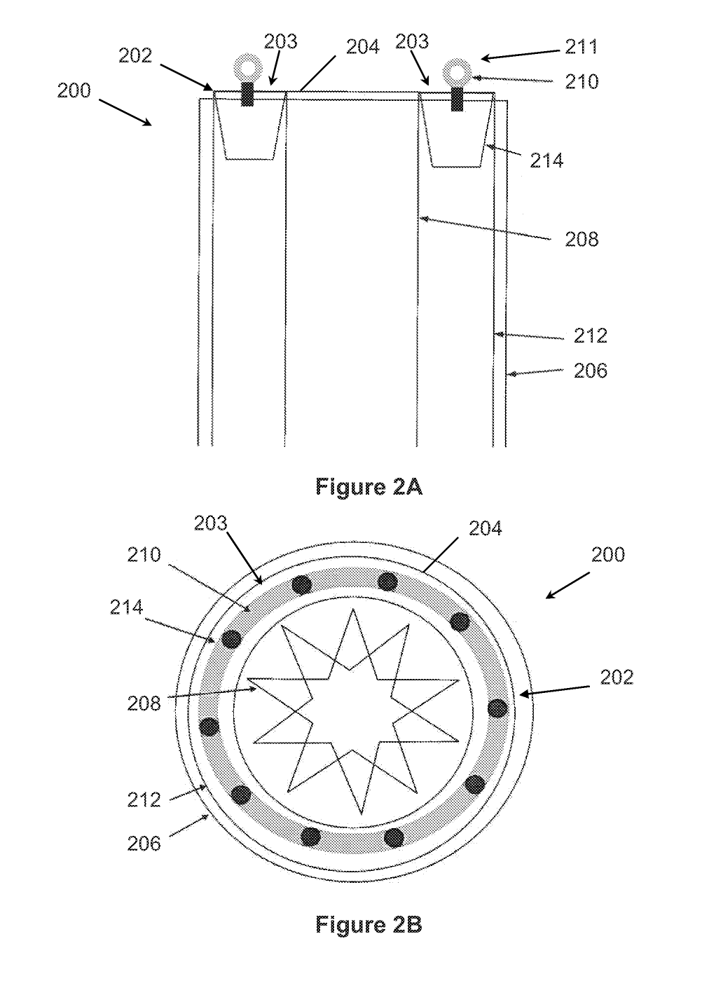

FIG. 2 illustrates a headgear assembly 202 for a baghouse filter 200 that includes a headgear 204 configured to allow for concentric arrangement of a first filter 206 and a second filter 208. The second filter 208 can preferably be nested within the first filter 206 and thereby utilize the empty space of the first filter 206 to improved the collection efficiency of the baghouse filter 200. However, it is alternatively contemplated that the second filter 208 can be disposed outside of the first filter 206. The first and second filters 206 and 208 can each be coupled to the headgear 204.

The headgear assembly 202 can also include at least one sealing apparatus 203 located between first filter 206 and second filter 208, and having one or more openings that can be sealed such that ash laden, partially cleaned air or gas can not pass through the openings. In this manner, the air or gas is forced to instead pass through second filter 208, which thereby collects at least a portion of the ash or other particulate on an exterior surface of the second filter 208.

Preferred headgear 204 is configured to allow for routine maintenance and replacement of the first and second filters 206 and 208. For example, it is contemplated that the second filter 208 could be removably coupled to the headgear 204 to provide for quick and easy removal of the second filter 208 from the headgear 204. It is especially preferred that the second filter 208 has a cartridge configuration, where the second filter 208 can be removed and replaced as needed.

The first filter 206 preferably comprises a filter bag disposed within a baghouse (not shown), and can be coupled to a retainer or cage assembly 212. The first filter 206 can have a circular horizontal cross-section, or could comprise any other commercially suitable shape including, for example, an oval. It is preferred that the first filter 206 is configured to remove at least 99% of particulate contained in an exhaust stream passing through the first filter 206 to produce a filtered stream. Advantageously, the second filter 208 can be disposed downstream of the first filter 206, and configured to remove at least 10%, and more preferably, at least 30%, 50%, 70%, 90%, or more, of the remaining particulate contained in the filtered stream that passes through the second filter 208. In this manner, more than 99% of the particulate of a stream passing through the baghouse filter 200 can be removed at a much lower cost.

In preferred embodiments, the second filter 208 can be a high-efficiency filter using commercially suitable material(s), such that the collection efficiency of the baghouse filter 200 is greater than 99%. Preferred material(s) are suitable for capture of small quantities of fine particulates, under normal operation, and larger quantities of particulate when needed such as if the first filter 206 has a partial failure, tear, hole, or other condition of normal wear and tear. The second filter 208 could have a pleated or fluted filter configuration to increase the overall surface area of the second filter 208 and provide a filter surface with a low pressure resistance and high gas volume to thereby maintain a low pressure drop across the second filter 208. Because the second filter 208 will typically capture small quantities of ash, the second filter 208 should be configured for a long life with or without on-line cleaning.

The headgear assembly 202 can also include a cleaning assembly 211 configured to facilitate cleaning of at least one of the first and second filters 206 and 208. In some contemplated embodiments, the cleaning assembly 211 can include a pulsed air supply pipe 210 through which pulsed air can be fed to at least one of the first and second filters 206 and 208. Although shown having a torus-shape configuration, it is contemplated that the pulsed air supply pipe 210 can have any commercially suitable configuration sufficient to deliver pulsed air to the baghouse filter 200. For example, a series of conduits could be used, each of which is fluidly coupled to one or more filter bags of a baghouse. Although a single pulse air supply pipe 210 is shown, it is contemplated that the baghouse filter 200 could include multiple pipes that provide cleaning air from one or more pulse air supplies and/or reverse air supplies, as necessary to remove accumulated particulate from at least one of the first and second filters 206 and 208. The baghouse filter 200 can further include one or more venturi nozzles 214, each of which advantageously accelerates the pulses of air to thereby facilitate flexing of the first filter 206. In some contemplated embodiments, the venturi nozzle 214 could be eliminated or not be used, or could be modified to accommodate the sealing apparatus 203 and the annular arrangement of first filter 206 and second filter 208.

It is contemplated that the baghouse filter 200 can be compartmentalized with respect to other baghouse filters within a baghouse such that each filter can be taken off-line, as necessary, to be cleaned using a cleaning assembly.

Cleaning of the second filter 208 advantageously reduces the downtime required to manually clean the filter, especially given the quick build-up of particulate on the filters, which allows baghouse filter 200 to operate for a longer duration before replacement of second filter 208. For example, in an 850 MW coal power plant that is burning a coal with 8% ash content, the total ash produced would be approximately 75,000 lb/hr. Assuming that the first filter 206 has a 99.9% removal rate, 75 lb/hr of ash would remain (approx. 0.01 lb/million BTU). Even if the second filter 208 removes only a portion of the remaining particulate, the surfaces of the second filter 208 will quickly accumulate particulate, plug, and add weight to the second filter 208.

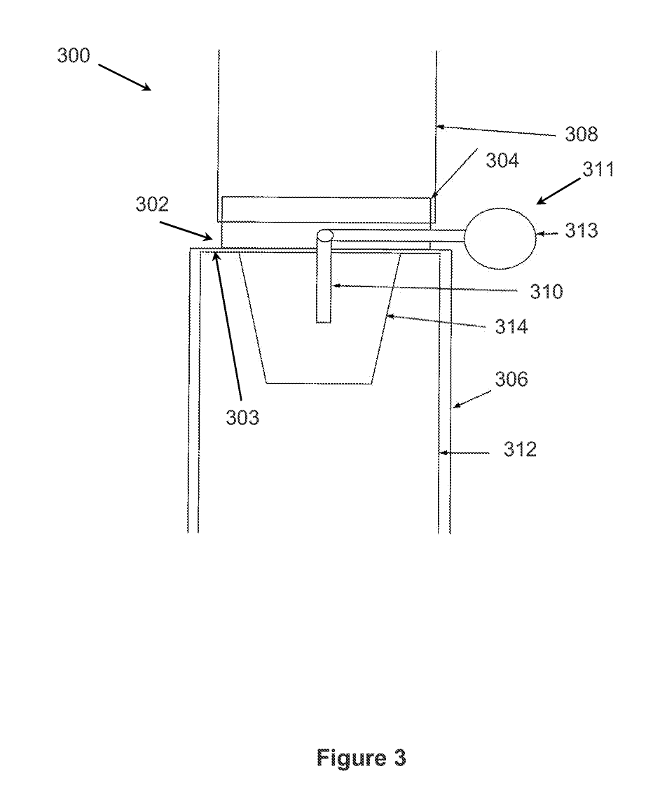

In FIG. 3, another embodiment of a headgear assembly 302 for a baghouse filter 300 is shown that includes a headgear 304 configured to allow for concentric arrangement of first and second filters 306 and 308. As shown in FIG. 3, the second filter 308 can be concentrically arranged with respect to the first filter 306, and disposed outside of the first filter 306. In this manner, the second filter 308 can be disposed in the plenum, downstream of the first filter 306, which provides for easier access to the second filter 308 for maintenance or replacement. In some contemplated embodiments, the second filter 308 can be removably coupled to the headgear 304, such that the second filter 308 can be easily removed as for cleaning, maintenance, or replacement.

In preferred embodiments, the second filter 308 comprises a pleated filter or cartridge filter capable of capturing at least a portion of the remaining particulate with low pressure resistance and the capacity for high volume passage of a stream.

The headgear assembly 302 can include a cleaning assembly 311 having a pulse air supply 313 configured to provide pulsed air to the first filter 306 via conduit 310. The pulses of air can advantageously remove accumulated particulate from the first filter 306, and potentially the second filter 308, and preferably with minimal down-time of the filter 300. Particulate removed from the second filter 308 can pass through the venturi nozzle 314 and collect at a bottom of the first filter 306. In some contemplated embodiments, the first filter 306 can include a resealable opening (not shown), which is configured to open to allow for removal of the collected particulate from the second filter 308, and to close to require the exhaust stream to pass through the first filter 306.

The headgear assembly 302 can also include at least one sealing apparatus 303 located between first filter 306 and second filter 308, which prevents ash laden, partially cleaned air or gas from passing through one or more sealed openings of the sealing apparatus 303. In this manner, all of the air or gas must instead pass through the second filter 308, such that at least a portion of the ash that passes through the first filter 306 collects on an interior surface of the second filter 308.

Alternatively, the baghouse filter 300 could include a reverse air supply (not shown) configured to direct an airflow to the first and second filters 306 and 308. In such embodiment, it is contemplated that the venturi nozzle 314 and pulse air supply conduit 310 could be eliminated. With respect to the remaining numerals in FIG. 3, the same considerations for like components with like numerals of FIG. 2 apply.

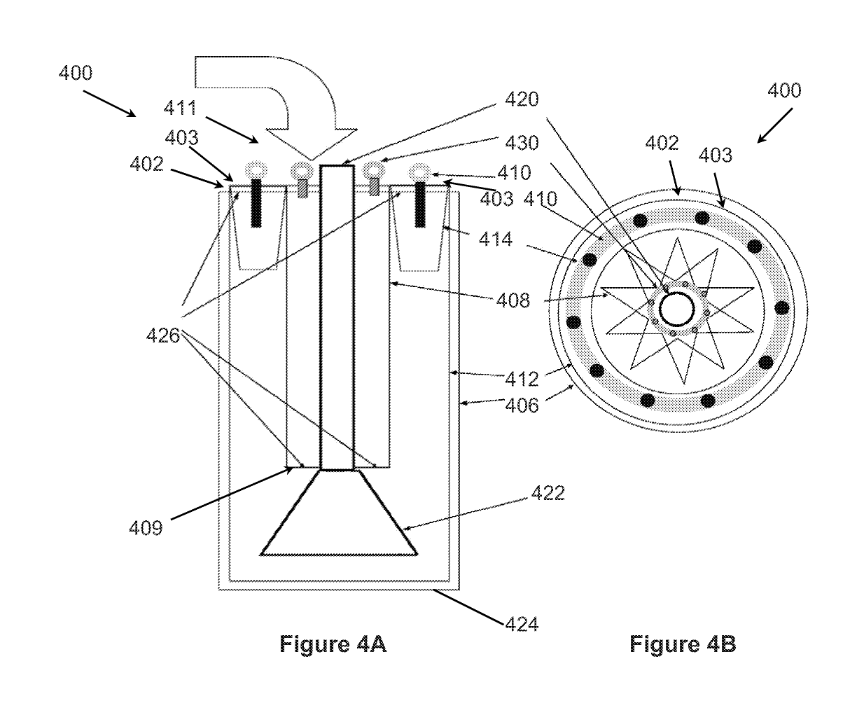

FIGS. 4A-4B illustrates yet another embodiment of a headgear assembly 402 for a baghouse filter 400 that includes a headgear 404 that is configured to allow for concentric arrangement of a first filter 406 and a second filter 408. The second filter 408 can be nested within the first filter 306, which thereby utilizes the empty space within the first filter 406 to thereby allow for replacement of existing bag filters with new baghouse filter 400 that includes a headgear 404 capable of accommodating a second filter 308 as well as a cleaning assembly 411 comprising a reverse air supply 430 and a pulse air supply 410.

The headgear assembly 402 can further include at least one sealing apparatus 403 located between first filter 406 and second filter 408, which prevents ash laden, partially cleaned air or gas from passing through one or more sealed openings of the sealing apparatus 403. In this manner, all of the air or gas must pass through the second filter 408, and at least a portion of the ash that passes through the first filter 406 can collect on an exterior surface of the second filter 408.

The second filter 408 can be fluidly coupled to an air supply 430 through which air can flow into the second filter 408 to thereby remove accumulated particulate from the second filter 408. High or low pressure air can be utilized, as necessary, to facilitate removal of particulate from the second filter 408. Alternatively, the supply could comprise pulses of air. The accumulated particulate cleaned from second filter 408 will collect inside first filter 406 at a bottom 424 of the first filter 406.

The headgear 404 can be further configured to allow for a suction tube 420 to be disposed within the first filter 406. Preferably, the suction tube 420 is concentrically arranged with respect to one or both of the first and second filters 406 and 408, and in especially preferred embodiments, the suction tube 420 can be nested within the second filter 408. The suction tube 420 can be sealed at one or more openings 426 at the bottom of the second filter 408 to direct the cleaning stream to pass through the suction tube 420 via suction head 422. The suction tube 420 is advantageously configured to remove at least a portion of the accumulated particulate from the second filter 408 that collects at a bottom 424 of a first filter 406 via suction head 422. Suction tube 420 can be isolated by a device such as a closed valve (not shown) during normal operation to prevent air from passing through the suction tube when not in use. During a cleaning cycle, the valve can be opened to remove accumulated particulate from the second filter 408, which collects at a bottom 424 of a first filter 406. While the accumulated particulate from the second filter 408 will typically be the fine portion of the flyash and should be easily removed by vacuuming, fluidizing air or other means of entraining the ash could be incorporated as needed. In this manner, the accumulated particulate can be removed on-line without requiring removal of the second filter 408 from the first filter 406, which thereby reduces the time and expense to maintain the baghouse filter 400. Removal of the particulate can occur during operation of the baghouse filter 400, or during a separate cleaning cycle.

Rather than include the suction tube 420, the first filter 406 can alternatively include one or more resealable openings (not shown) through which the accumulated particulate can pass such that the accumulated particulate can collect at a bottom of the baghouse.

In some contemplated embodiments, the second filter 408 could be integral with the cage assembly 412 and/or suction tube 420. In addition, it is contemplated that the second filter 408 and suction tube 420 could be divided into sections, such that the second filter 408 and suction tube 420 can be extendable through the addition or removal of one or more sections.

In some contemplated embodiments, the venturi tube 414 could be eliminated or not used, or could be modified to accommodate a sealing apparatus 403 and the annular arrangement of first filter 206 and second filter 208.

As discussed above with respect to FIG. 2, the headgear can also be configured to accommodate a pulse air supply system 410, which is capable of delivering pulses of air to the first filter 406, which facilitates on-line cleaning of the first filter 406. With respect to the remaining numerals in each of FIGS. 4A-4B, the same considerations for like components with like numerals of FIG. 2 apply.

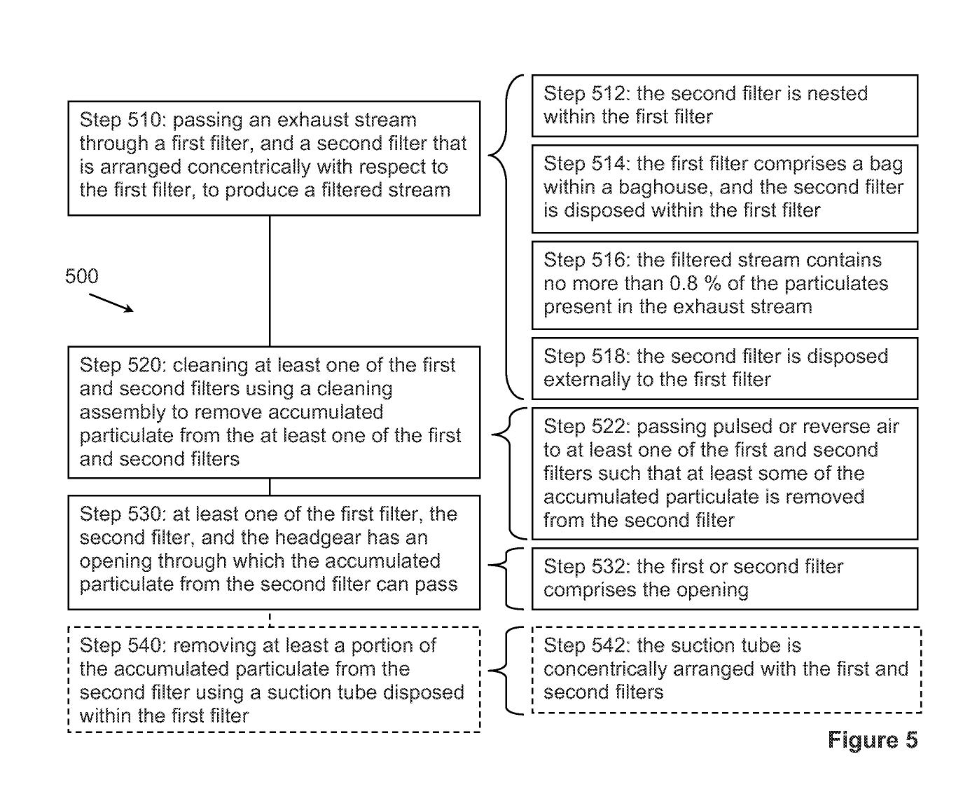

In FIG. 5, a method 500 of facilitating on-line cleaning of a baghouse filter is shown that includes the step 510 of passing an exhaust stream through a first filter, and a second filter that is arranged concentrically with respect to the first filter, to produce a filtered stream. In step 512, the second filter can be nested within the first filter. In step 514, the first filter can comprise a bag within a baghouse, and the second filter can be disposed within the first filter.

In preferred embodiments, the filtered stream contains no more than 0.8% of the particulates present in the exhaust stream (step 516). Even more preferably, the filtered stream can contain no more than 0.6%, 0.5%, 0.4%, 0.3%, 0.2%, 0.1%, or less, of the particulates present in the exhaust stream. Thus, by utilizing method 500, it is contemplated that more than 99%, and preferably, more than 99.5% of the particulates can be removed from an exhaust stream.

At least one of the first and second filters can be cleaned in step 520 using a cleaning assembly to remove accumulated particulate from the at least one of the first and second filters. Reverse or pulsed air can optionally be passed at least one of the first and second filters in step 522, in an amount sufficient to remove at least some of the accumulated particulate from the second filter.

In step 530, at least one of the first filter, the second filter, and the headgear has an opening through which the accumulated particulate from the second filter can pass. In step 532, the first or second filter can comprise the opening.

At least a portion of the accumulated particulate from the second filter can be removed in step 540 by using a suction tube disposed within the first filter. In step 542, the suction tube can be concentrically arranged with the first ands second filters.

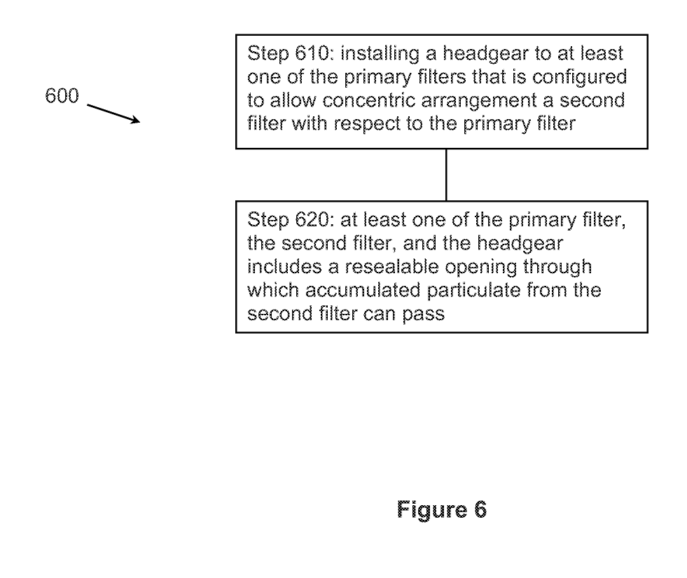

FIG. 6 illustrates a method 600 of retrofitting a baghouse having a plurality of primary filters. In step 610, a headgear can be installed to at least one of the primary filters, and configured to allow concentric arrangement a second filter with respect to the primary filter.

In step 620, at least one of the primary filter, the second filter, and the headgear can include a resealable opening through which accumulated particulate from the second filter can pass.

Rather than utilize a second filter, alternative embodiments include utilizing a dry ESP followed by a fabric filter (similar to the EPRI™ COHPAC™ or TOXECON™ arrangement), two fabric filters in series, or a wet ESP as a final particulate control step. However, these options are all quite expensive when compared with adding a second filter to the filter bag, especially considering that the second filters' purpose is to capture up to 90-99% of the remaining particulate matter when the first filter has already captured up to more than 99% of the bulk particulate.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A headgear assembly for a baghouse filter, comprising:
a headgear configured to allow for concentric arrangement of first and second filters;
a cleaning assembly configured to facilitate cleaning of at least one of the first and second filters, wherein the first and second filters are coupled to the headgear; and
wherein at least one of the first filter, the second filter, and the headgear includes an opening through which accumulated particulate from the second filter can pass.

2. The headgear assembly of claim 1, wherein the second filter is nested within the first filter.

3. The headgear assembly of claim 1, wherein the first or second filter comprises the opening.

4. The headgear assembly of claim 1, wherein the headgear comprises the opening.

5. The headgear assembly of claim 1, wherein the first filter comprises a bag in a baghouse, and the second filter is disposed within the first filter.

6. The headgear assembly of claim 1, wherein the cleaning assembly comprises at least one of a pulse air supply and a reverse air supply, and wherein the cleaning assembly is fluidly coupled to at least one of the first and second filters.

7. The headgear assembly of claim 1, wherein the cleaning assembly comprises a reverse air or vacuum supply fluidly coupled to the second filter.

8. The headgear assembly of claim 1, further comprising a suction tube disposed within the first filter, and configured to remove at least a portion of the accumulated particulate from the second filter.

9. The headgear assembly of claim 8, wherein the suction tube is concentrically arranged with the first and second filters.

10. The headgear assembly of claim 1, wherein the first filter is configured to remove at least 99% of particulate contained in an exhaust stream passing through the first filter to produce a filtered stream, and wherein the second filter is configured to remove at least 10% of particulate contained in the filtered stream passing through the second filter.

11. The headgear assembly of claim 10, wherein the second filter is configured to remove at least 50% of the particulate contained in the filtered stream passing through the second filter.

12. The headgear assembly of claim 1, wherein the second filter is disposed externally to the first filter.

13. The headgear assembly of claim 1, wherein the second filter is removably coupled to the headgear.

14. The headgear assembly of claim 1, wherein the opening is a resealable opening.

15. A method of facilitating on-line cleaning of a baghouse filter, comprising:
passing an exhaust stream through a first filter, and a second filter that is arranged concentrically with respect to the first filter, to produce a filtered stream; and
cleaning at least one of the first and second filters using a cleaning assembly to remove accumulated particulate from the at least one of the first and second filters; and
wherein at least one of the first and second filter has an opening through which the accumulated particulate from the second filter can pass.

16. The method of claim 15, wherein the second filter is nested within the first filter.

17. The method of claim 15, wherein the first or second filter comprises the opening.

18. The method of claim 15, wherein the first filter comprises a bag within a baghouse, and the second filter is disposed within the first filter.

19. The method of claim 15, wherein the step of cleaning further comprises passing pulsed or reverse air to at least one of the first and second filters such that at least some of the accumulated particulate is removed from the second filter.

20. The method of claim 15, further comprising removing at least a portion of the accumulated particulate from the second filter using a suction tube disposed within the first filter.

21. The method of claim 20, wherein the suction tube is concentrically arranged with the first ands second filters.

22. The method of claim 15, wherein the filtered stream contains no more than 0.8% of the particulate present in the exhaust stream.

23. The method of claim 15, wherein the second filter is disposed externally to the first filter.

24. The method of claim 15, wherein the opening is a resealable opening.

25. A method of retrofitting a baghouse having a plurality of primary filters, comprising:
installing a headgear to at least one of the primary filters that is configured to allow concentric arrangement a second filter with respect to the primary filter; and
wherein at least one of the primary filter, the second filter, and the headgear includes an opening through which accumulated particulate from the second filter can pass.

26. The method of claim 25, wherein the opening is a resealable opening.
